(19) United States
(12) Patent Application Publication
(10) Pub. No.: US 2011/0173661 A1
(43) Pub. Date: Jul. 14, 2011

(54) INTERACTIVE SYSTEM

(75) Inventor: Chih-Hao Chen, Taipei County (TW)

(73) Assignee: AMTRAN TECHNOLOGY CO. LTD, Taipei County (TW)

(21) Appl. No.: 12/713,188

(22) Filed: Feb. 26, 2010

(30) Foreign Application Priority Data
Jan. 14, 2010 (TW) 99100964

(51) Int. Cl. H04N 5/445

(52) U.S. Cl. 725/46; 725/58

(57) ABSTRACT

An interactive system including a display device and a universal remoter is provided. An interactive application program is embedded into the display device, and the universal remoter is used for manipulating the display device. When the interactive application program is activated by a user through the universal remoter, the display device displays an interactive patterned interface so as to guide the user to set the universal remoter for learning the behaviors of a remoter corresponding to at least one peripheral equipment which is or is not linked with the display device.

### CROSS-REFERENCE TO RELATED APPLICATION

This application claims the priority benefit of Taiwan application serial no. 99100964, filed on Jan. 14, 2010. The entirety of the above-mentioned patent application is hereby incorporated by reference herein and made a part of specification.

### BACKGROUND OF THE INVENTION

1. Field of the Invention

The present invention relates to an interactive system. More particularly, the present invention relates to an interactive system having a learning function.

2. Description of Related Art

Along with booming development of technology, display devices (for example, televisions) in the future trend to be light, slim and portable. In an actual application, a user can carry the television to different locations (for example, from a living room to a bedroom), though peripheral equipments (such as a DVD player, an audio device, etc. fixed in the living room) of the television are not moved. Therefore, when the user carries the television to the bedroom, the user can only manipulate the television through an exclusive remoter of the television, and cannot manipulate the peripheral equipments. Even if remoters of the peripheral equipments have been brought to the bedroom, manipulations of the peripheral equipments cannot be achieved, so that it is inconvenient for utilization.

To resolve such problem, a remote control technique has been developed, by which the user in the bedroom is allowed to manipulate the DVD player and the audio device, etc. disposed in the living room through the exclusive remoters of the peripheral equipments via the television. However, according to such a solution, the user has to carry at least two remoters, so as to simultaneously manipulate the television and the peripheral equipments.

For example, when the user is about to manipulate the television in the bedroom, the user has to manipulate the television through the exclusive remoter of the television, and when the user is about to manipulate the DVD player and the audio device, etc. disposed in the living room from the bedroom, the user has to use the exclusive remoters of the DVD player and the audio device, so as to manipulate the DVD player and the audio device. In other words, the user has to constantly change different remoters, so as to simultaneously manipulate the television in the bedroom and the peripheral equipments located in the living room. Therefore, it is inconvenient and complicated for utilization.

### SUMMARY OF THE INVENTION

Accordingly, the present invention is directed to an interactive system, by which the problem of the related art can be resolved.

The present invention provides an interactive system including a display device and a universal remoter. An interactive application program is embedded in the display device, and the universal remoter is used for manipulating the display device. When a user activates the interactive application program through the universal remoter, the display device displays an interactive patterned interface, so as to guide the user to set the universal remoter for learning behaviors of a remoter corresponding to at least one peripheral equipment which is or is not linked with the display device.

In an embodiment of the present invention, the interactive patterned interface provides an all setting mode, a partial setting mode and a match wizard mode for the user to select through the universal remoter.

In an embodiment of the present invention, when the user selects the all setting mode or the match wizard mode, the interactive patterned interface guides the user to set the universal remoter for learning all of behaviors of the remoter corresponding to the peripheral equipment.

In an embodiment of the present invention, the universal remoter records a launch carrier of the remoter corresponding to the peripheral equipment and remote signals without carriers corresponding to all of buttons of the remoter, so as to learn all of the behaviors of the remoter corresponding to the peripheral equipment.

In an embodiment of the present invention, the launch carrier of the remoter corresponding to the peripheral equipment and the remote signals without carriers corresponding to all of buttons of the remoter are analysed or recorded in advance by the display device, and are transmitted to the universal remoter through a wireless transmission approach for recording.

In an embodiment of the present invention, when the user selects the partial setting mode, the interactive patterned interface guides the user to set the universal remoter for learning partial behaviors of the remoter corresponding to the peripheral equipment.

In an embodiment of the present invention, the universal remoter records a launch carrier of the remoter corresponding to the peripheral equipment and remote signals without carriers corresponding to partial buttons of the remoter, so as to learn the partial behaviors of the remoter corresponding to the peripheral equipment.

In an embodiment of the present invention, the launch carrier of the remoter corresponding to the peripheral equipment and the remote signals without carriers corresponding to the partial buttons of the remoter are analysed or recorded in advance by the display device, and are transmitted to the universal remoter through a wireless transmission approach for recording.

In an embodiment of the present invention, the interactive patterned interface guides the user to set the universal remoter for learning the behaviors of the remoter corresponding to the peripheral equipment through a text block, a voice or an animation approach.

In an embodiment of the present invention, the display device is a television.

In an embodiment of the present invention, the peripheral equipment linked with the display device includes a player device, an audio device or other home appliances.

In an embodiment of the present invention, the peripheral equipment that is not linked with the display device includes an air conditioner, an electric fan or other home appliances.

According to the above descriptions, in the interactive system of the present invention, the interactive application program is established in the display device, and when the user activates the interactive application program through the universal remoter, the display device displays the interactive patterned interface, so as to guide the user to set the universal remoter for learning all of or a part of behaviors of the remoter corresponding to at least one peripheral equipment which is linked with the display device through a text block, a voice or an animation approach. In other words, the universal remoter can be used to simultaneously manipulate the display device and all of the peripheral equipments after the learning processes. Therefore, it is unnecessary for the user to constantly change different remoters to manipulate different electronic products, so that the problem of the related art is effectively resolved.

On the other hand, the interactive application program inbuilt to the display device can also guide the user to set the universal remoter for learning behaviors of a remoter corresponding to a peripheral equipment which is not linked with the display device, for example, any home appliance that can be manipulated through a remoter (such as an air conditioner, an electric fan, etc.). Therefore, after the learning processes, the universal remoter can be used to simultaneously manipulate all of the electronic products in the house that can be manipulated through a remoter, so as to facilitate utilization.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating an interactive system according to an embodiment of the present invention.

FIG. 2 is a schematic diagram illustrating an interactive patterned interface according to an embodiment of the present invention.

FIG. 3 is a schematic diagram illustrating a processing concept of an infrared (IR) receiving module according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

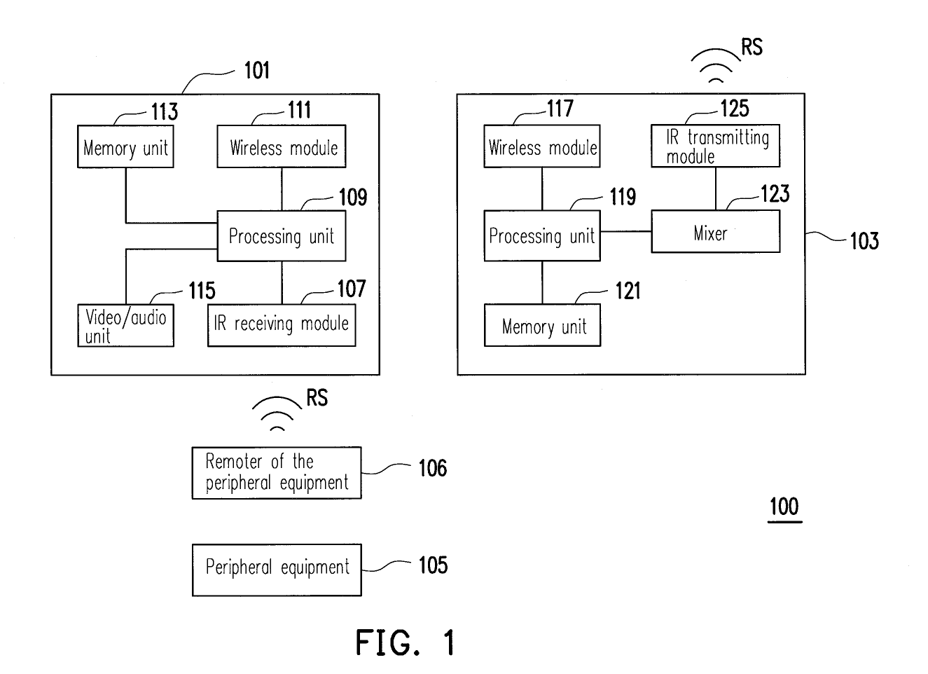

FIG. 1 is a schematic diagram illustrating an interactive system 100 according to an embodiment of the present invention. Referring to FIG. 1, the interactive system 100 includes a display device 101 (for example, a television, though the present invention is not limited thereto) and a universal remoter 103. In the present embodiment, the display device 101 may include an infrared (IR) receiving module 107, a processing unit 109 (for example, any type of microprocessor), a wireless module 111, a memory unit 113 and a video/audio unit 115.

The IR receiving module 107 is used for receiving and processing a remote signal RS sent from the universal remoter 103 and a remote signal RS sent from a remoter 106 corresponding to a peripheral equipment 105 (for example, a DVD player or an audio device, though the present invention is not limited thereto) linked with (connected to) the display device 101. The processing unit 109 is coupled to the IR receiving module 107, and is used for executing an interactive application program inbuilt to the display device 101, and analysing the remote signal RS processed by the IR receiving module 107. The wireless module 111 is coupled to the processing unit 109, and is used for performing wireless communication with the universal remoter 103. The memory unit 113 is coupled to the processing unit 109, and is used for storing the interactive application program and information analysed by the processing unit 109. The video/audio unit 115 is coupled to the processing unit 109, and is used for displaying images and playing sounds.

On the other hand, the universal remoter 103 is used for manipulating the display device 101, and may include a wireless module 117, a processing unit 119 (for example, any type of microprocessor), a memory unit 121, a mixer 123, and an IR transmitting module 125. The wireless module 117 is used for performing wireless communication with the display device 101. The memory unit 121 is used for storing information transmitted from the display device 101. The processing unit 119 is coupled between the wireless module 117 and the memory unit 121, and is used for processing information stored in the memory unit 121. The mixer 123 is coupled to the processing unit 119, and is used for mixing information processed by the processing unit 119. The IR transmitting module 125 is coupled to the mixer 123, and is used for receiving an output of the mixer 123, so as to send the remote signal RS.

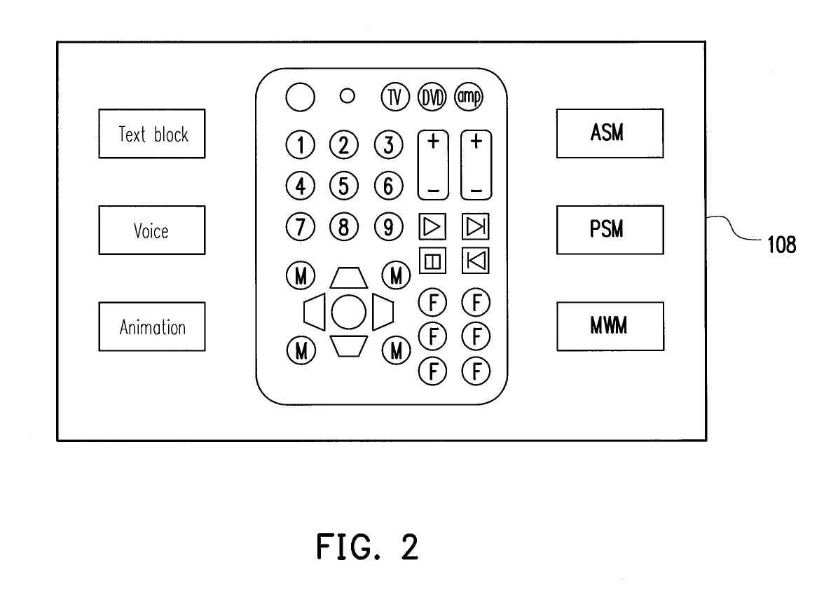

In the present embodiment, when a user activates the interactive application program (i.e. the processing unit 109 reads and executes the interactive application program stored in the memory unit 113) inbuilt to the display device 101 through the universal remoter 103, the display device 101 displays an interactive patterned interface 108 (shown in FIG. 2) through the video/audio unit 115, so as to guide the user to set the universal remoter 103 for learning behaviors of the remoter 106 through a text block, a voice or an animation approach. In other words, the universal remoter 103 can learn the behaviors of the remoter 106 through a guiding of the interactive patterned interface 108 shown in FIG. 2.

In detail, when the user activates the interactive application program inbuilt to the display device 101 through the universal remoter 103, the interactive patterned interface 108 displayed by the video/audio unit 115 can provide as a match wizard mode MWM, an all setting mode ASM and a partial setting mode PSM for the user to select through the universal remoter 103. Herein, an appearance of a remoter shown in the interactive patterned interface 108 of FIG. 2 is similar to that of the universal remoter 103, though the present invention is not limited thereto.

In the present embodiment, when the user selects the all setting mode ASM, the interactive patterned interface 108 can guide the user to set the universal remoter 103 for learning all of behaviors of the remoter 106. Namely, the universal remoter 103 can learn functions of all buttons on the remoter 106. In detail, once the user selects the all setting mode ASM through the universal remoter 103, the interactive patterned interface 108 first guides the user to put aside the universal remoter 103, and guides the user to pick up the remoter 106 through the text block, the voice or the animation approach, so as to instruct the user to one-by-one input each of the buttons on the remoter 106. Setting of a numeral key 1 is taken as an example below, and the others can be deduced by analogy.

For example, when the interactive patterned interface 108 instructs the user to set the numeral key 1 through the text block, the voice or the animation approach, the interactive patterned interface 108 can first light up the numeral key 1 (or change a color of the numeral key 1, but not limited thereto), and then instructs the user to hold a numeral key 1 on the remoter 106 for a predetermined time period (for example, several seconds, which can be determined according to an actual design requirement) through the text block, the voice or the animation approach. Now, the IR receiving module 107 receives a plurality of remote signals RS corresponding to the numeral key 1 on the remoter 106, and processes the remote signals RS for providing to the processing unit 109 accordingly.

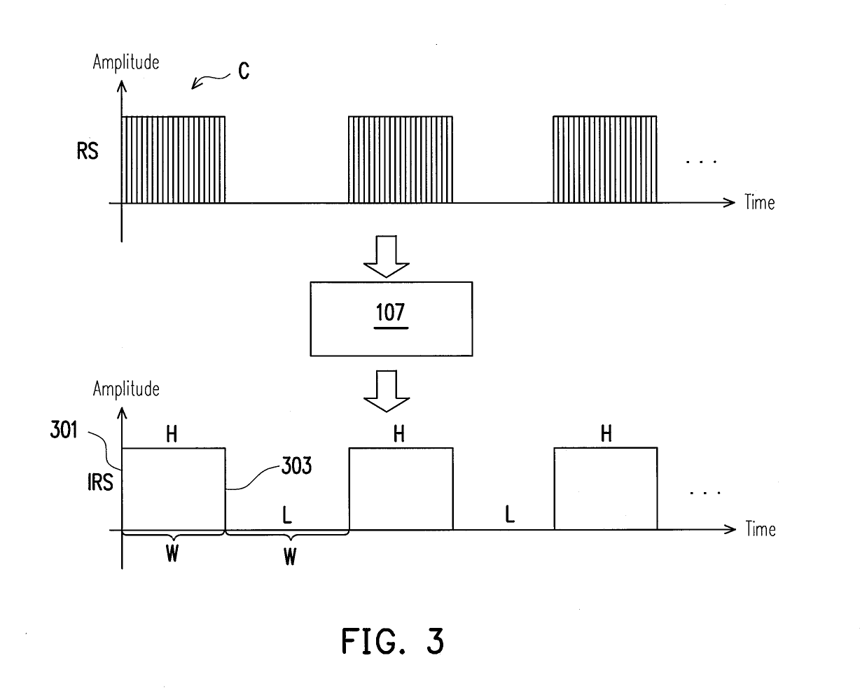

Referring to FIG. 3, the IR receiving module 107 can filter a carrier C of each received remote signal RS corresponding to the numeral key 1 on the remoter 106, so as to obtain a remote signal IRS without the carrier C, and then the IR receiving module 107 provides the remote signal RS with the carrier C and the remote signal IRS without the carrier C to the processing unit 109. Therefore, the processing unit 109 can trigger a timer (not shown) in internal of the processing unit 109 according to an edge variation (for example, each positive edge 301 and each negative edge 303) of the remote signal IRS without the carrier C, so as to sequentially obtain a time interval W between any two edges and a polarity H/L thereof of the remote signal IRS without the carrier C. In the present embodiment, a counting method of the timer within the processing unit 109 is diversified. For example, the timer is first reset for each edge triggering, and then starts to count from 0, or starts to count up/count down from a certain value for each edge triggering, though the concept thereof are the same, and therefore detailed descriptions thereof are not repeated.

It should be noticed that since there are various types of the remoters in the market, IR signals sent by the remoters are also different. Therefore, in the present embodiment, a purpose that the interactive patterned interface 108 guides the user to press the numeral key 1 on the remoter 106 is to facilitate the processing unit 109 obtaining information and calculating/analysing an integral signal wavelength of the remote signal RS corresponding to the numeral key 1 on the remoter 106. Generally, most of the remoters 106 can continuously send a same signal waveform when a button thereon is pressed until the button is released, while some remoters can send another signal waveform (with a wavelength shorter than that of a first signal waveform) after sending a second signal waveform (including the second signal waveform) for representing that the signal waveform is repeatedly sent. Therefore, as long as the above information is obtained, the signal wavelength can be calculated/analysed.

In the present embodiment, a method of calculating/analysing the signal wavelength of the remote signal sent by the remoter is that the signal wavelength defined by the time interval W between a first and a second edges and the polarity H/L thereof of the remote signal is approximately a signal header and is unique, so that as long as the processing unit 109 determines a time between two similar signal headers (a difference there between is allowed), the signal wavelength is obtained. In case of a remoter having a design without sending the signal head, a series of signal waveforms can be compared to find repeat waveforms or waveforms with regularity, so as to obtain the integral signal wavelength, though the present invention is not limited thereto. Further, the processing unit 109 can calculate a frequency of the carrier C (i.e. a reciprocal of a period of the carrier C) according to the period of the carrier C in the remote signal RS with the carrier C.

Therefore, after the processing unit 109 sequentially obtains the time interval W of any two edges and the polarity H/L thereof of the remote signal IRS without the carrier C, and the integral signal wavelength corresponding to the numeral key 1 of the remoter 106 and the frequency of the carrier C, the processing unit 109 can further store such information into the memory unit 113 until the interactive patterned interface 108 guides the user to input the other buttons on the remoter 106 and after the corresponding processing and storing operations are all completed. Therefore, the display device 101 can analyse the carrier C and the remote signals RS corresponding to all of the buttons on the remoter 106 (wherein the analysing operation has to be succeed, and if the analysing operation is failed, it can be repeated until success, or the analysing operation can be performed for a predetermined times), so as store all analysed information into the memory unit 113.

Once the interactive patterned interface 108 guides the user to one-by-one input all of the buttons on the remoter 106 and after the corresponding processing and storing operations are all completed, based on the text block, the voice or the animation approach, the interactive patterned interface 108 instructs the user to use the universal remoter to select whether or not to transmit all of the information stored in the memory unit 113 to the universal remoter 103 through to a wireless transmission for recording. If the user selects to transmit the information (i.e. agree), all of the information stored in the memory unit 113 is transmitted to the universal remoter 103, and is stored into the memory unit 121.

In this way, as long as a timer (not shown) within the processing unit 119 is set to be the same to that of the processing unit 109, the processing unit 119 can react the user's operation performed to the universal remoter 103, so as to reconstruct the remote signals IRS without the carriers C corresponding to all of the buttons on the remoter 106 and the carrier C according to the information stored in the memory unit 121 (a read sequence of the information has to be considered), and provide the signals to the mixer 123 for mixing (i.e. multiplying). Therefore, the IR transmitting module 125 can transmit the remote signal RS originally belonged to the remoter 106 according to an output of the mixer 123. In other words, the universal remoter 103 can learn all of the behaviors of the remoter 106 by recording the carrier C and the remote signals IRS without the carrier C corresponding to all of the buttons on the remoter 106.

In the present embodiment, by recalling/activating the interactive application program inbuilt to the display device 101, and after the learning process, the universal remoter 103 can manipulate different electronic devices. For example, after the universal remoter 103 learns the behaviors of remoters of the DVD player and the audio device, when the user presses a DVD key on the universal remoter 103, the universal remoter 103 can serve as an original remoter of the DVD player, when the user presses a TV key on the universal remoter 103, the universal remoter 103 can serve as an original remoter of the display device 101, and when the user presses an amp key on the universal remoter 103, the universal remoter 103 can serve as an original remoter of the audio device, and the others are deduced by analogy.

On the other hand, when the user selects the partial setting mode PSM, the interactive patterned interface 108 can guide the user to set the universal remoter 103 for learning partial behaviors of the remoter 106. Namely, the universal remoter 103 only learns functions of a part of buttons (which can be buttons that are frequently used by the user) on the remoter 106. In the present embodiment, once the user selects the partial setting mode PSM, the functions of original undesired buttons can be changed to the functions of desired buttons. For example, the user can notify the interactive patterned interface 108 the buttons to be changed through the universal remoter 103 in advance. In this way, the interactive patterned interface 108 can change icons or colors of these buttons, and guide the user to press the buttons of the corresponding peripheral equipments, so as to facilitate the universal remoter 103 performing recording. However, since a method that the interactive patterned interface 108 guides the user to set the universal remoter 103 for learning the partial behaviors of the remoter 106 is similar to the method that the interactive patterned interface 108 guides the user to set the universal remoter 103 for learning all of the behaviors of the remoter 106, so that detailed description thereof is not repeated.

In the present embodiment, the display device 101 can analyse the carrier C of the remoter 106 and the remote signals RS corresponding to the partial buttons of the remoter 106, so as to store the analysed information in the memory unit 113, and transmit the analysed information to the universal remoter 103 through a wireless transmission approach for recording (i.e. storing in the memory unit 121). In this way, as long as the timer in the processing unit 119 is set to be the same to that of the processing unit 109, the processing unit 119 can react the user's operation performed to the universal remoter 103, so as to reconstruct the carrier C and the remote signals IRS without the carrier C corresponding to a part of the buttons on the remoter 106 according to the information stored in the memory unit 121, and provide the signals to the mixer 123 for mixing (i.e. multiplying). Therefore, the IR transmitting module 125 can transmit the remote signal RS originally belonged to the remoter 106 according to an output of the mixer 123. In other words, the universal remoter 103 can learn partial behaviors of the remoter 106 by recording the carrier C and the remote signals IRS without the carrier C corresponding to a part of the buttons on the remoter 106.

Moreover, in the present embodiment, when the user selects the match wizard mode MWM, the interactive patterned interface 108 can guide the user to set the universal remoter 103 for learning all of behaviors of the remoter 106. Different to the all setting mode ASM, in the match wizard mode MWM, the display device 101 can recognize any of the buttons on the remoter 106, and compare the buttons with an inbuilt database (i.e. information of remoters 106 of various manufactures that is stored in the memory unit 113 in advance), so as to find a brand, a model number and all information of the buttons of the remoter 106.

In this way, the interactive patterned interface 108 can notify the user a match-success information and related information of the remoter 106 through the text block, the voice or the animation approach. Then, the display device 101 can transmit the related information of the matched remoter 106 to the universal remoter 103 through the wireless transmission approach, and stores the related information into the memory unit 121. It should be noticed that the match wizard mode MWM can quickly and conveniently assist the user setting the universal remoter 103, though if the information of the remoter 106 is not stored in the database, the match process is failed, and now the interactive patterned interface 108 can notify the user to switch to the all setting mode ASM or the partial setting module PSM through the text block, the voice or the animation approach, so as to resolve the problem of inadequate database.

According to the above descriptions, since the universal remoter 103 can learn all of or a part of the behaviors of the remoter 106 through a guiding of the interactive patterned interface 108 shown in FIG. 2, when the user carries the display device 101 to different locations, the user can still use the single universal remoter 103 to switch a television mode (the TV key of FIG. 2), a play mode (the DVD key of FIG. 2) or an audio mode (the amp key of FIG. 2) according to a remote control technique, so as to manipulate the display device 101 located at different locations and the other peripheral equipments 105 (i.e. the DVD player and the audio device), so that a utilization convenience is improved. Moreover, the information stored in the memory units 113 and 121 can be correspondingly added/reduced according to an actual design requirement as long as the operations of the aforementioned embodiment are maintained.

In summary, in the interactive system of the present invention, an interactive application program is established in the television, and when the user activates the interactive application program through the universal remoter, the television can display an interactive patterned interface, so as to guide the user to set the universal remoter for learning all of or a part of behaviors of the remoter corresponding to at least one peripheral equipment linked with the television through a text block, a voice or an animation approach. In other words, the universal remoter can be used to simultaneously manipulate the display device and all of the peripheral equipments after the learning processes. Therefore, it is unnecessary for the user to constantly change different remoters to manipulate different electronic products, so that the problem of the related art is effectively resolved.

Although the peripheral equipments (the DVD player and the audio device) linked with the display device (the television) are taken as an example in the above embodiment, the present invention is not limited thereto. In detail, in the other embodiments of the present invention, the interactive application program inbuilt to the display device (the television) can also guide the user to set the universal remoter for learning behaviors of a remoter corresponding to a peripheral equipment which is not linked with the display device (the television), for example, any home appliance that can be manipulated through a remoter (such as an air conditioner, an electric fan, etc.). Therefore, after the learning processes, the universal remoter can be used to simultaneously manipulate all of the electronic products in the house that can be manipulated through a remoter, so as to facilitate utilization.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An interactive system, comprising:
a display device, inbuilt with an interactive application program; and
a universal remoter, the universal remoter is used for manipulating the display device, wherein when a user activates the interactive application program through the universal remoter, the display device displays an interactive patterned interface, so as to guide the user to set the universal remoter for learning behaviors of a remoter corresponding to at least one peripheral equipment which is or is not linked with the display device.

2. The interactive system as claimed in claim 1, wherein the interactive patterned interface provides an all setting mode, a partial setting mode and a match wizard mode for the user to select through the universal remoter.

3. The interactive system as claimed in claim 2, wherein when the user selects the all setting mode or the match wizard mode, the interactive patterned interface guides the user to set the universal remoter for learning all of behaviors of the remoter corresponding to the peripheral equipment.

4. The interactive system as claimed in claim 3, wherein the universal remoter records a launch carrier of the remoter corresponding to the peripheral equipment and remote signals without carriers corresponding to all of buttons of the remoter, so as to learn all of the behaviors of the remoter corresponding to the peripheral equipment.

5. The interactive system as claimed in claim 4, wherein the launch carrier of the remoter corresponding to the peripheral equipment and the remote signals without carriers corresponding to all of buttons of the remoter are analysed by the display device, and are transmitted to the universal remoter through a wireless transmission approach for recording.

6. The interactive system as claimed in claim 4, wherein the launch carrier of the remoter corresponding to the peripheral equipment and the remote signals without carriers corresponding to all of buttons of the remoter are recorded in advance by the display device, and are transmitted to the universal remoter through a wireless transmission approach for recording.

7. The interactive system as claimed in claim 2, wherein when the user selects the partial setting mode, the interactive patterned interface guides the user to set the universal remoter for learning partial behaviors of the remoter corresponding to the peripheral equipment.

8. The interactive system as claimed in claim 7, wherein the universal remoter records a launch carrier of the remoter corresponding to the peripheral equipment and remote signals without carriers corresponding to partial buttons of the remoter, so as to learn the partial behaviors of the remoter corresponding to the peripheral equipment.

9. The interactive system as claimed in claim 8, wherein the launch carrier of the remoter corresponding to the peripheral equipment and the remote signals without carriers corresponding to the partial buttons of the remoter are analysed by the display device, and are transmitted to the universal remoter through a wireless transmission approach for recording.

10. The interactive system as claimed in claim 1, wherein the interactive patterned interface guides the user to set the universal remoter for learning the behaviors of the remoter corresponding to the peripheral equipment through a text block, a voice or an animation approach.
